(19) United States
(12) Patent Application Publication
(10) Pub. No.: US 2022/0085670 A1
(43) Pub. Date: Mar. 17, 2022

(54) MOTOR

(71) Applicant: Nidec Corporation, Kyoto (JP)

(72) Inventor: Yoshitsugu Sasaguri, Kyoto (JP)

(21) Appl. No.: 17/471,356

(22) Filed: Sep. 10, 2021

(30) Foreign Application Priority Data
Sep. 11, 2020 (JP) 2020-152860

(51) Int. Cl. H02K 1/27; H02K 1/14; H02K 11/20

(52) U.S. Cl. CPC H02K 1/27; H02K 11/20; H02K 1/148

(57) ABSTRACT

A motor includes first teeth each including a tip portion with extending portions extending in a circumferential direction. A first gap is between the extending portions adjacent to each other. Second teeth of the motor each include a tip portion provided with extending portions extending in a circumferential direction. A second gap is between the extending portions adjacent to each other. The first gap includes a first tip gap and a second tip gap narrower than the first tip gap. The second gap includes a third tip gap and a fourth tip gap wider than the third tip gap. When viewed from an up-down direction, the first tip gap and the third tip gap overlap each other, and the second tip gap and the fourth tip gap overlap each other. A detector is at a position corresponding to the first tip gap.

### CROSS-REFERENCE TO RELATED APPLICATIONS

The present application claims priority under 35 U.S.C. § 119 to Japanese Patent Application No. 2020-152860, filed on Sep. 11, 2020, the entire contents of which are hereby incorporated herein by reference.

### 1. FIELD OF THE INVENTION

The present disclosure relates to a motor.

### 2. BACKGROUND

Motors including detection elements such as Hall elements are known. Conventional motors include detection elements, rotor yokes, and magnets provided on the rotor yokes. The conventional motors are each configured such that a part of the magnet is exposed from the rotor yoke. The detection element is disposed outside the magnet corresponding to the part of the magnet exposed from the rotor yoke. The detection element detects leakage magnetic flux of the exposed part of the magnet.

The conventional motors are each thinned by disposing the detection element outside the magnet. Unfortunately, the conventional motors each include the detection element disposed outside the magnet, and thus are each likely to enlarge radially.

### SUMMARY

An example embodiment of a motor of the present disclosure includes a stationary assembly and a rotary assembly. The rotary assembly rotates about a central axis extending in an up-down direction. The rotary assembly includes magnets. The stationary assembly includes a stator radially opposing the magnets. The stator includes a first stator core and a second stator core. The second stator core is stacked on the first stator core in the up-down direction. The first stator core includes first core pieces stacked in the up-down direction. The first stator core includes a first core back in an annular shape surrounding the central axis. The first stator core further includes first teeth. The first teeth are arranged along a circumferential direction. The first teeth extend radially from the first core back. The first teeth each include a tip portion in a radial direction provided with extending portions extending in the circumferential direction. The first teeth include adjacent first teeth with the extending portions between which a first gap is defined. The second stator core includes second core pieces stacked in the up-down direction. The second stator core includes a second core back in an annular shape surrounding the central axis. The second stator core further includes second teeth. The second teeth are arranged along the circumferential direction. The second teeth extend radially from the second core back. The second teeth each include a tip portion in the radial direction provided with extending portions extending in the circumferential direction. The second teeth include adjacent second teeth with the extending portions between which a second gap is defined. The first gap includes a first tip gap and a second tip gap. The second tip gap is narrower than the first tip gap. The second gap includes a third tip gap and a fourth tip gap. The fourth tip gap is wider than the third tip gap. When viewed from the up-down direction, the first tip gap and the third tip gap overlap each other. When viewed from the up-down direction, the second tip gap and the fourth tip gap overlap each other. The stationary assembly further includes detection elements. The detection elements detect magnetic flux generated from the corresponding ones of the magnets. The detection elements are each at a position corresponding to the first tip gap or a position corresponding to the fourth tip gap.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic cross-sectional view of a motor according to a first example embodiment of the present disclosure.

FIG. 2 is a perspective view illustrating internal structure of the motor according to the first example embodiment.

FIG. 3A is a plan view illustrating a detection element and a circuit board according to an example embodiment of the present disclosure.

FIG. 3B is a perspective view illustrating a detection element and a circuit board according to an example embodiment of the present disclosure.

FIG. 4 is a plan view illustrating magnets, a detection element, and a circuit board according to an example embodiment of the present disclosure.

FIG. 5A is a perspective view illustrating the structure of a stationary assembly according to an example embodiment of the present disclosure.

FIG. 5B is an enlarged perspective view of a stator according to an example embodiment of the present disclosure.

FIG. 6A is a plan view of a first stator core according to an example embodiment of the present disclosure.

FIG. 6B is an enlarged plan view illustrating a portion of the first stator core.

FIG. 7A is a plan view of a second stator core according to an example embodiment of the present disclosure.

FIG. 7B is an enlarged plan view illustrating a portion of the second stator core.

FIG. 8 is a schematic diagram illustrating structure of a motor according to the first example embodiment.

FIG. 9 is a plan view of a stator according to an example embodiment of the present disclosure.

FIG. 10 is a schematic diagram illustrating structure of a motor according to a second example embodiment of the present disclosure.

FIG. 11A is a plan view of a third stator core according to an example embodiment of the present disclosure.

FIG. 11B is an enlarged plan view illustrating a portion of the third stator core.

FIG. 12 is a schematic diagram illustrating structure of a motor according to a third example embodiment of the present disclosure.

### DETAILED DESCRIPTION

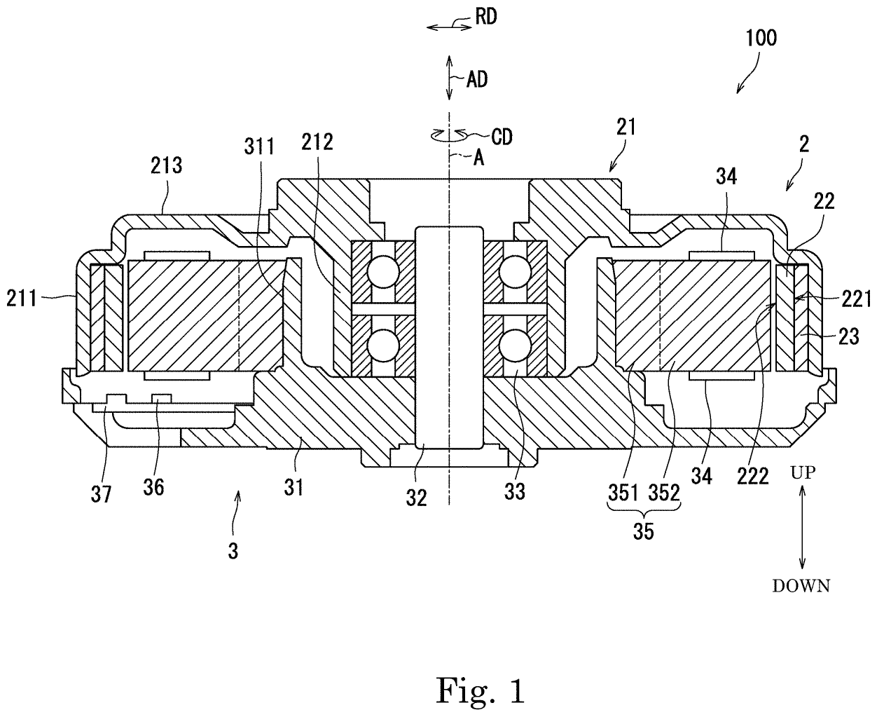

Hereinafter, motors according to example embodiments of the present disclosure will be described with reference to the drawings (FIGS. 1 to 12). However, the present disclosure is not limited to the following example embodiments. Description of portions with duplicated description may be eliminated as appropriate. In the drawings, the same or corresponding portions are denoted by the same reference numerals, and description of such portions will not be duplicated.

In the present specification, for convenience, a direction of a central axis A (see FIG. 1) of a motor may be described as an up-down direction. However, the up-down direction, an upward direction, and a downward direction are defined for convenience of description, and do not need to coincide with a vertical direction. The up-down direction is defined only for convenience of description, but does not limit an orientation during use of a motor according to the present disclosure. Additionally, as illustrated in FIG. 1, a direction parallel to the central axis A of the motor is referred to as an “axial direction AD”, and a radial direction and a circumferential direction centered on the central axis A of the motor are referred to as a “radial direction RD” and a “circumferential direction CD”, respectively. The term, “plan view”, indicates that an object is viewed from the axial direction AD. In other words, the “plan view” indicates that the object is viewed from the up-down direction. Additionally, a “parallel direction” in the present invention includes a substantially parallel direction.

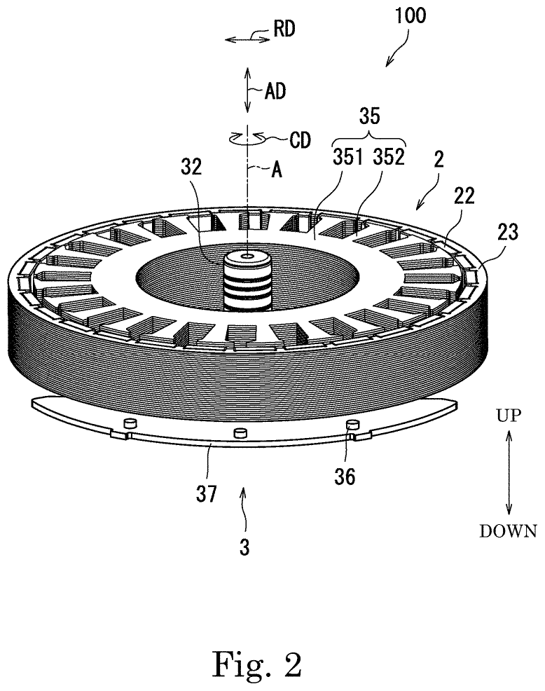

Next, a first example embodiment will be described with reference to FIGS. 1 to 9. First, a motor 100 of the present example embodiment will be described with reference to FIGS. 1 and 2. FIG. 1 is a schematic cross-sectional view of the motor 100 of the present example embodiment. FIG. 2 is a perspective view illustrating internal structure of the motor 100 of the present example embodiment. In FIG. 2, a first frame 21, a second frame 31, a plurality of bearings 33, and a coil 34, which are illustrated in FIG. 1, are eliminated for convenience of understanding. The motor 100 of the present example embodiment is an outer-rotor motor. As illustrated in FIG. 1, the motor 100 of the present example embodiment includes a rotary assembly 2 and a stationary assembly 3.

The rotary assembly 2 indicates a portion that rotates in the motor 100. The rotary assembly 2 rotates about the central axis A extending in the up-down direction (axial direction AD). In other words, the central axis A is a rotation center of the rotary assembly 2. As illustrated in FIG. 1, the rotary assembly includes the first frame 21. The rotary assembly 2 further includes a plurality of magnets 22 (see FIG. 2) and a rotor holder 23.

The stationary assembly 3 indicates a portion that is stationary in the motor 100. The stationary assembly 3 includes the second frame 31, a shaft 32, the plurality of bearings 33, and the coil 34. The stationary assembly 3 further includes a stator 35, a detection element 36, and a circuit board 37.

The first frame 21 includes an outer cylindrical portion 211, an inner cylindrical portion 212, and a lid portion 213.

The outer cylindrical portion 211 has a substantially cylindrical shape and extends in the axial direction AD. The outer cylindrical portion 211 surrounds the central axis A. The outer cylindrical portion 211 constitutes an outer surface of the first frame 21 in the radial direction RD. In other words, the outer cylindrical portion 211 constitutes an outer peripheral surface of the first frame 21.

The inner cylindrical portion 212 has a substantially cylindrical shape and extends in the axial direction AD. The inner cylindrical portion 212 surrounds the central axis A. The inner cylindrical portion 212 is disposed inside the outer cylindrical portion 211 in the radial direction RD.

The lid portion 213 is provided from an upper end of the outer cylindrical portion 211 to an upper end of the inner cylindrical portion 212 to cover a space between the outer cylindrical portion 211 and the inner cylindrical portion 212. The lid portion 213 constitutes an upper surface of the first frame 21.

The plurality of magnets 22 is arranged along the circumferential direction CD (see FIG. 2). The magnets 22 are each a permanent magnet, for example. The rotor holder 23 has a substantially cylindrical shape and extends in the axial direction AD (see FIG. 2). The rotor holder 23 surrounds the central axis A. The rotor holder 23 is a rotor yoke, for example. The rotor holder 23 may be a stacked body in which magnetic bodies identical in shape are stacked. The magnetic bodies are each an electromagnetic steel sheet, for example.

The rotor holder 23 holds the plurality of magnets 22. In the present example embodiment, the plurality of magnets 22 is fixed to an inner peripheral surface of the rotor holder 23. The rotor holder 23 is held by the first frame 21. More specifically, the rotor holder 23 is fixed to an inner peripheral surface of the outer cylindrical portion 211.

Each of the magnets 22 has an outer peripheral surface 221 far away from the central axis A and an inner peripheral surface 222 close to the central axis A. In the present example embodiment, the rotor holder 23 is configured to cover all outer peripheral surfaces 221 of the magnets 22. According to the present example embodiment, leakage magnetic flux can be reduced as compared with structure in which a part of the outer peripheral surface of each of magnets is not covered with the rotor holder.

The second frame 31 is disposed on a first side in the axial direction AD of the first frame 21 to cover an opening of the first frame 21. In other words, the second frame 31 constitutes a housing of the motor 100 together with the first frame 21. In the present example embodiment, the second frame 31 is disposed below the first frame 21 to cover a lower opening of the first frame 21.

The second frame 31 includes a cylindrical portion 311. The cylindrical portion 311 has a substantially cylindrical shape and extends in the axial direction AD. The cylindrical portion 311 surrounds the central axis A. The cylindrical portion 311 of the second frame 31 is disposed between the outer cylindrical portion 211 and the inner cylindrical portion 212 of the first frame 21.

The shaft 32 is a columnar member extending in the axial direction AD inside the stator 35 in the radial direction RD. Specifically, the shaft 32 is disposed along the central axis A. The shaft 32 is disposed inside the inner cylindrical portion 212 of the first frame 21 in the radial direction RD. The shaft 32 has an end on the first side in the axial direction AD, the end being fixed to the second frame 31. In the present example embodiment, the shaft 32 has a lower end fixed to the second frame 31.

The plurality of bearings 33 rotatably supports the rotary assembly 2 with respect to the stationary assembly 3. More specifically, the plurality of bearings 33 rotatably supports the inner cylindrical portion 212 of the first frame 21 with respect to the shaft 32. The bearings 33 each have a substantially annular structure. In the present example embodiment, the stationary assembly 3 has two bearings 33. The two bearings 33 face each other in the axial direction AD. That is, the two bearings 33 are arranged along the axial direction AD.

The stator 35 is an armature that generates a magnetic flux in accordance with a drive current. The stator 35 has a substantially annular structure centered on the central axis A (see FIG. 2). The stator 35 faces the plurality of magnets 22 in the radial direction RD. In the present example embodiment, the stator 35 is supported by the cylindrical portion 311 of the second frame 31 and is arranged inside the plurality of magnets 22 in the radial direction RD.

The stator 35 includes a core back portion 351 and a plurality of teeth 352 (see FIG. 2). The core back portion 351 has a substantially annular shape centered on the central axis A (see FIG. 2). The plurality of teeth 352 extends in the radial direction RD from the core back portion 351. Here, a tooth 352 extends outward in the radial direction RD from the core back portion 351.

The coil 34 includes a conductive wire wound around the tooth 352. A method for winding the conductive wire may be so-called “concentrated winding” in which the conductive wire is individually wound around each of the teeth 352, or may be so-called “distributed winding” in which the conductive wire is wound over two or more teeth 352.

When the motor 100 is driven, a drive current is supplied from an external power supply to the coil 34 through a drive circuit. When the drive current is supplied, magnetic flux is generated around the plurality of teeth 352 of the stator 35. Then, torque in the circumferential direction CD is generated by interaction between the magnetic flux generated from the plurality of magnets 22 and the magnetic flux generated from the plurality of teeth 352. As a result, the rotary assembly 2 starts to rotate about the central axis A.

The circuit board 37 faces the stator 35 in the up-down direction (axial direction AD). In other words, the circuit board 37 is disposed on the first side in the axial direction AD of the stator 35. Here, the circuit board 37 is disposed below the stator 35. Wiring is formed on the circuit board 37.

The detection element 36 is mounted on the circuit board 37. The detection element 36 detects magnetic flux generated from the magnets 22. The detection element 36 outputs a detection signal to the circuit board 37 when detecting the magnetic flux generated from the magnets 22.

Specifically, the detection element 36 detects the magnetic flux generated from the respective magnets 22 once during one rotation of the rotary assembly 2. Thus, the detection signal output from the detection element 36 during the rotation of the rotary assembly 2 corresponds to the rotation of the rotary assembly 2. The detection signal thus indicates information on the rotation of the rotary assembly 2. For example, the detection signal indicates a rotational speed of the rotary assembly 2 or a rotational position of the rotary assembly 2. The detection signal is output to an external control unit using the circuit board 37, and is used for control of the motor 100 using the external control unit. The detection element 36 is, for example, a Hall element or a magnetoresistive element.

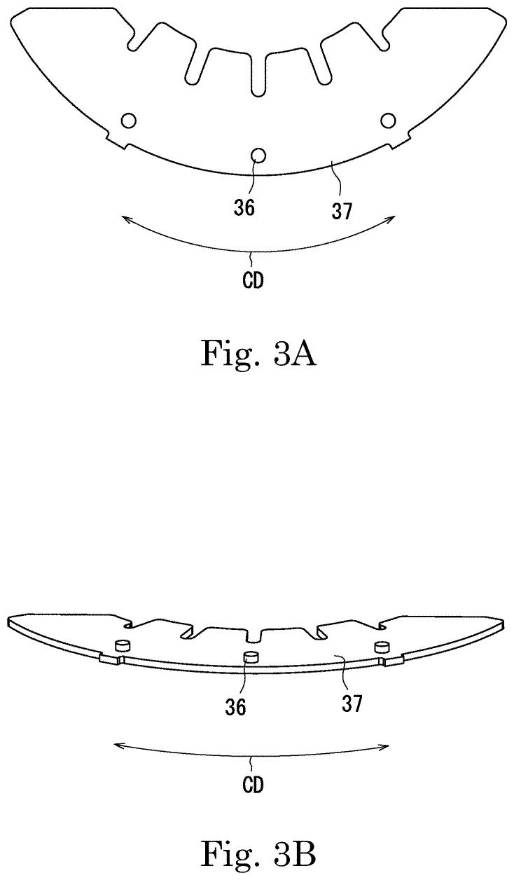

Subsequently, the detection element 36 and the circuit board 37 will be further described with reference to FIGS. 2, 3A, and 3B. FIG. 3A is a plan view illustrating the detection element and the circuit board 37. FIG. 3B is a perspective view illustrating the detection element 36 and the circuit board 37.

As illustrated in FIGS. 2, 3A, and 3B, the circuit board 37 has an arc shape and extends along the circumferential direction CD. In the present example embodiment, the stationary assembly 3 includes three detection elements 36. The three detection elements 36 are arranged along the circumferential direction CD. The three detection elements 36 are arranged at positions where two or more of the detection elements 36 do not simultaneously detect magnetic flux generated from an identical magnet 22. The stationary assembly 3 may have one or two detection elements 36, or may have four or more detection elements 36.

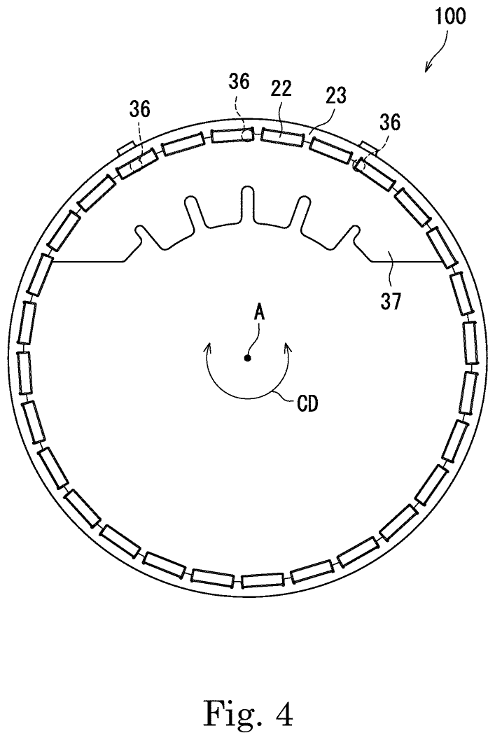

Subsequently, a positional relationship between the detection element 36 and the magnet 22 will be described with reference to FIG. 4. FIG. 4 is a plan view illustrating the plurality of magnets 22, the detection element 36, and the circuit board 37.

As illustrated in FIG. 4, in the present example embodiment, the detection element 36 is disposed immediately below a region through which the plurality of magnets 22 passes during rotation of the rotary assembly 2. Thus, the detection element 36 can detect magnetic flux generated from the magnets 22 with higher sensitivity. The detection element 36 is disposed radially inside an outer peripheral surface of the rotor holder 23. This enables the circuit board 37 to be reduced in area, so that the motor 100 can be prevented from increasing in size. The outer peripheral surface of the rotor holder 23 indicates a radially outer surface of the rotor holder 23.

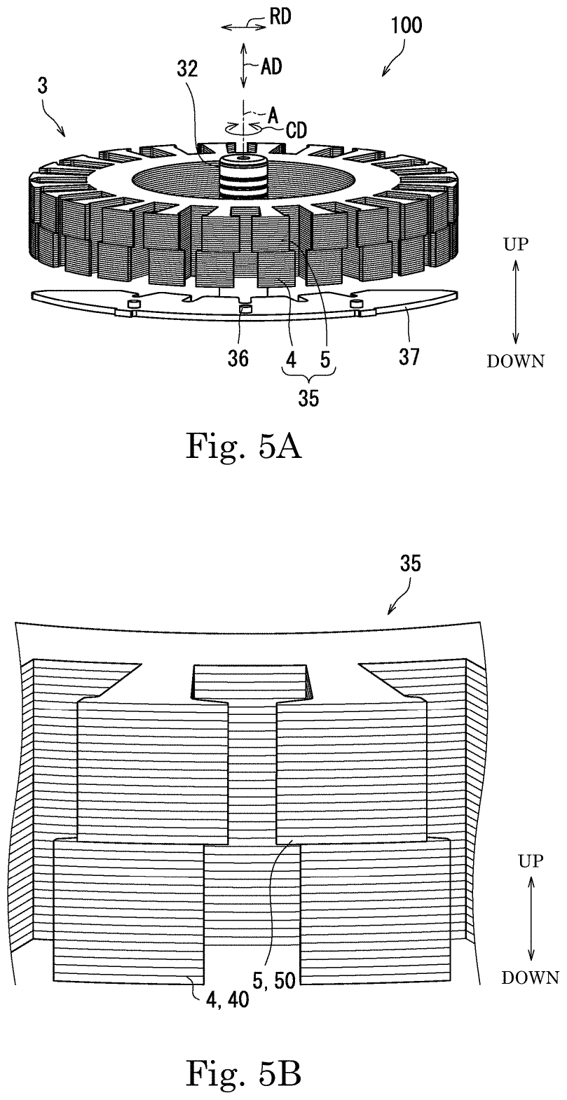

Subsequently, structure of the stationary assembly 3 will be further described with reference to FIGS. 5A and 5B. FIG. 5A is a perspective view illustrating the structure of the stationary assembly 3. In FIG. 5A, the second frame 31, the plurality of bearings 33, and the coil 34 illustrated in FIG. 1 are eliminated for convenience of understanding.

As illustrated in FIG. 5A, the stator 35 includes first stator cores 4 and second stator cores 5. The second stator cores 5 are stacked on the corresponding first stator cores 4 in the up-down direction. In the present example embodiment, the second stator cores 5 are stacked on above the corresponding first stator cores 4 and fixed to the corresponding first stator cores 4. The first stator cores 4 and the second stator cores 5 have a substantially annular structure centered on the central axis A.

FIG. 5B is an enlarged perspective view of the stator 35. As illustrated in FIG. 5B, the first stator core 4 includes a plurality of first core pieces 40 stacked in the up-down direction. The plurality of first core pieces 40 is identical in shape. The first core pieces 40 each have a substantially annular shape centered on the central axis A. The first core pieces 40 are each a magnetic body in the shape of a thin plate. The magnetic bodies are each an electromagnetic steel sheet, for example.

Similarly, a second stator core 5 includes a plurality of second core pieces 50 stacked in the up-down direction. The plurality of second core pieces 50 is identical in shape. The second core pieces 50 each have a substantially annular shape centered on the central axis A. The second core pieces 50 are each a magnetic body in the shape of a thin plate. The magnetic bodies are each an electromagnetic steel sheet, for example.

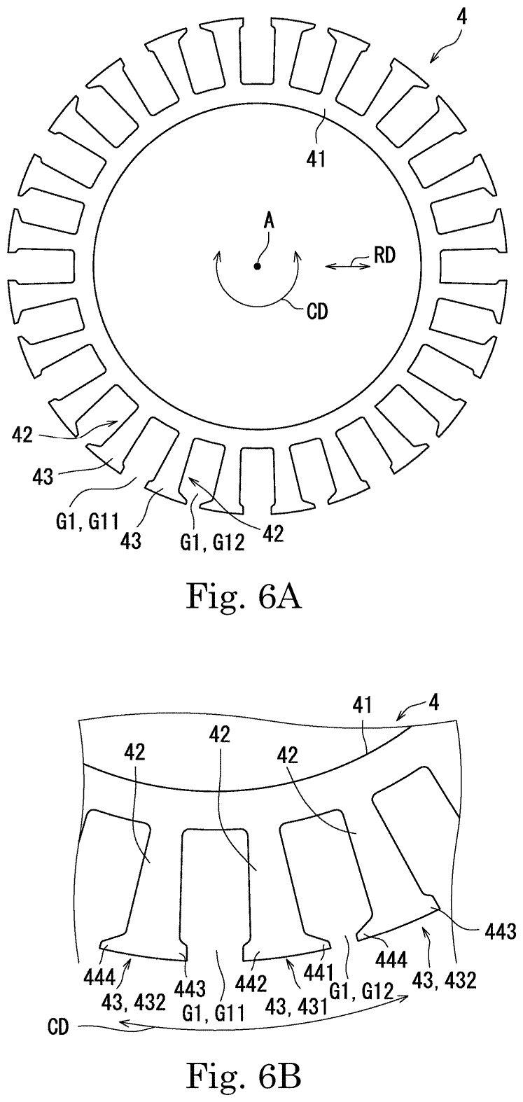

Subsequently, the first stator core 4 will be described with reference to FIG. 6A. FIG. 6A is a plan view of the first stator core 4. As illustrated in FIG. 6A, the first stator core 4 includes a first core back 41 in an annular shape surrounding the central axis A and a plurality of first teeth 42. The plurality of first teeth 42 is disposed along the circumferential direction CD and extends in the radial direction RD from the first core back 41. More specifically, the first core back 41 has a substantially annular shape centered on the central axis A. Here, a first tooth 42 extends outward in the radial direction RD from the first core back 41.

The first teeth 42 each include a tip portion in the radial direction RD provided with an extending portion 43. Here, an outer tip portion of the first tooth 42 in the radial direction RD has the extending portion 43. The extending portion 43 of the first tooth 42 extends in the circumferential direction CD. That is, the outer tip portion of the first tooth 42 in the radial direction RD extends in the circumferential direction CD.

The plurality of first teeth 42 includes adjacent first teeth 42 with extending portions 43 between which a first gap G1 is formed. The first gap G1 includes a first tip gap G11 and a second tip gap G12. The second tip gap G12 is narrower than the first tip gap G11. In the present example embodiment, the plurality of first teeth 42 alternately forms the first tip gap G11 and the second tip gap G12 in the circumferential direction CD.

Subsequently, the first stator core 4 will be further described with reference to FIG. 6B. FIG. 6B is an enlarged plan view illustrating a part of the first stator core 4. As illustrated in FIG. 6B, the extending portion 43 of the first stator core 4 includes a first extending portion 431 and a second extending portion 432. In the present example embodiment, the first extending portion 431 and the second extending portion 432 are alternately provided in the circumferential direction CD.

The first extending portion 431 has a first protrusion 441 and a second protrusion 442. The first protrusion 441 extends toward a first side in the circumferential direction CD with respect to the first tooth 42. The second protrusion 442 extends toward a second side in the circumferential direction CD with respect to the first tooth 42. The first protrusion 441 extends longer than the second protrusion 442.

The second extending portion 432 has a third protrusion 443 and a fourth protrusion 444. The third protrusion 443 extends toward the first side in the circumferential direction CD with respect to the first tooth 42. The fourth protrusion 444 extends toward the second side in the circumferential direction CD with respect to the first tooth 42. The fourth protrusion 444 extends longer than the third protrusion 443.

The first extending portion 431 and the second extending portion 432 face each other in the circumferential direction CD across the first gap G1. Thus, the first protrusion 441 faces the fourth protrusion 444 in the circumferential direction CD. The second protrusion 442 faces the third protrusion 443 in the circumferential direction CD. As a result, the first tip gap G11 is formed between the second protrusion 442 and the third protrusion 443. The second tip gap G12 is formed between the first protrusion 441 and the fourth protrusion 444. The first tip gap G11 and the second tip gap G12 are alternately formed in the circumferential direction CD.

As described above with reference to FIGS. 6A and 6B, the extending portion 43 of the first stator core 4 has an extended length toward the first side in the circumferential direction CD, the extended length being different from an extended length toward the second side in the circumferential direction CD. Thus, torque of the motor 100 can be increased as compared with structure in which an extending portion has short extended lengths toward both the first side and the second side in the circumferential direction.

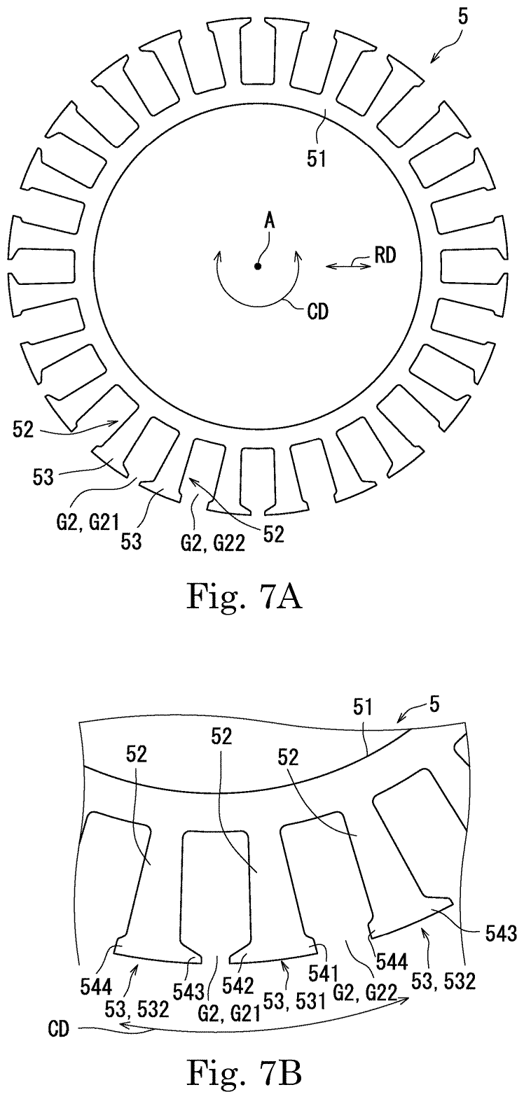

Subsequently, the second stator core 5 will be described with reference to FIG. 7A. FIG. 7A is a plan view of the second stator core 5. As illustrated in FIG. 7A, the second stator core 5 includes a second core back 51 in an annular shape surrounding the central axis A and a plurality of second teeth 52. The plurality of second teeth 52 is disposed along the circumferential direction CD and extends in the radial direction RD from the second core back 51. More specifically, the second core back 51 has a substantially annular shape centered on the central axis A. Here, a second tooth 52 extends outward in the radial direction RD from the second core back 51.

The second teeth 52 each include a tip portion in the radial direction RD provided with an extending portion 53. Here, an outer tip portion of the second tooth 52 in the radial direction RD has the extending portion 53. The extending portion 53 of the second tooth 52 extends in the circumferential direction CD. That is, the outer tip portion of the second tooth 52 in the radial direction RD extends in the circumferential direction CD.

The plurality of second teeth 52 includes adjacent second teeth 52 with extending portions 53 between which a second gap G2 is formed. The second gap G2 includes a third tip gap G21 and a fourth tip gap G22. The fourth tip gap G22 is wider than the third tip gap G21. In the present example embodiment, the plurality of second teeth 52 alternately forms the third tip gap G21 and the fourth tip gap G22 in the circumferential direction CD.

Subsequently, the second stator core 5 will be further described with reference to FIG. 7B. FIG. 7B is an enlarged plan view illustrating a part of the second stator core 5. As illustrated in FIG. 7B, the extending portion 53 of the second stator core 5 includes a third extending portion 531 and a fourth extending portion 532. In the present example embodiment, the third extending portion 531 and the fourth extending portion 532 are alternately provided in the circumferential direction CD.

The third extending portion 531 has a fifth protrusion 541 and a sixth protrusion 542. The fifth protrusion 541 extends toward the first side in the circumferential direction CD with respect to the second tooth 52. The sixth protrusion 542 extends toward the second side in the circumferential direction CD with respect to the second tooth 52. The fifth protrusion 541 extends shorter than the sixth protrusion 542.

The fourth extending portion 532 has a seventh protrusion 543 and an eighth protrusion 544. The seventh protrusion 543 extends toward the first side in the circumferential direction CD with respect to the second tooth 52. The eighth protrusion 544 extends toward the second side in the circumferential direction CD with respect to the second tooth 52. The eighth protrusion 544 extends shorter than the seventh protrusion 543.

The third extending portion 531 and the fourth extending portion 532 face each other in the circumferential direction CD across the second gap G2. Thus, the fifth protrusion 541 faces the eighth protrusion 544 in the circumferential direction CD. The sixth protrusion 542 faces the seventh protrusion 543 in the circumferential direction CD. As a result, the third tip gap G21 is formed between the sixth protrusion 542 and the seventh protrusion 543. The fourth tip gap G22 is formed between the fifth protrusion 541 and the eighth protrusion 544. The third tip gap G21 and the fourth tip gap G22 are alternately formed in the circumferential direction CD.

As described above with reference to FIGS. 7A and 7B, the extending portion 53 of the second stator core 5 has an extended length toward the first side in the circumferential direction CD, the extended length being different from an extended length toward the second side in the circumferential direction CD. Thus, torque of the motor 100 can be increased as compared with structure in which an extending portion has short extended lengths toward both the first side and the second side in the circumferential direction.

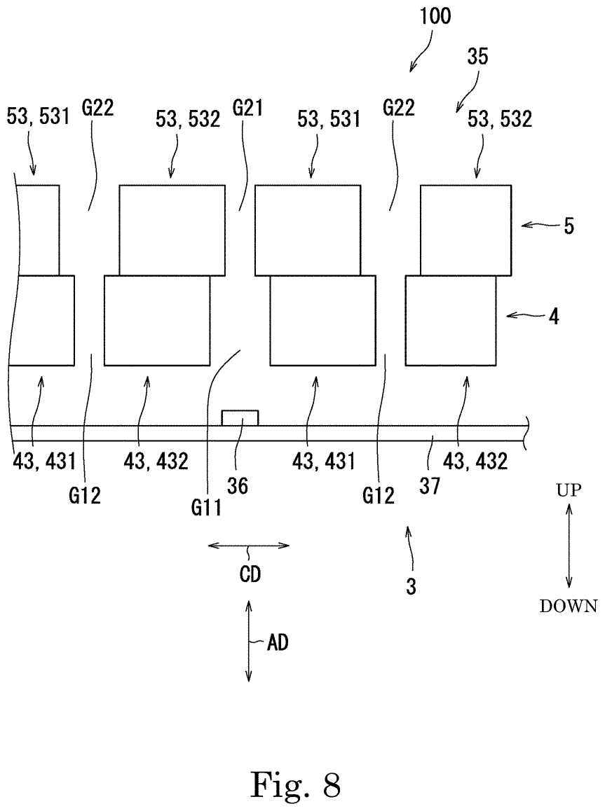

Subsequently, structure of the motor 100 of the present example embodiment will be further described with reference to FIG. 8. FIG. 8 is a schematic diagram illustrating the structure of the motor 100 of the present example embodiment. Specifically, FIG. 8 illustrates the stator 35, the detection element 36, and the circuit board 37. However, in FIG. 8, the core back portion 351 (the first core back 41 and the second core back 51) is eliminated for easy understanding.

As illustrated in FIG. 8, the detection element 36 is disposed at a position corresponding to the first tip gap G11. Thus, the present example embodiment enables preventing the motor 100 from increasing in size. Additionally, sensitivity of detection of magnetic flux using the detection element 36 can be improved.

Examples of structure for improving sensitivity of detection of magnetic flux using a detection element include structure in which a part of each magnet is exposed from a rotor holder. This structure requires use of a magnet having a longer length in the axial direction AD than the rotor holder to expose a part of the magnet from the rotor holder. Thus, a motor is likely to increase in size in the axial direction AD.

In contrast, the present example embodiment allows the detection element 36 to be disposed at a position corresponding to a relatively wide gap among gaps between the extending portions 43 of the adjacent first teeth 42. As a result, the amount of magnetic flux of the magnets 22 detected by the detection element 36 can be increased. Thus, the detection element 36 can detect magnetic flux generated from the magnets 22 with higher sensitivity.

Additionally, a part of each magnet 22 is not required to be exposed from the rotor holder 23, so that the motor 100 can be prevented from increasing in size in the axial direction AD. Furthermore, a part of each magnet 22 is not exposed from the rotor holder 23, so that leakage magnetic flux is less likely to occur as compared with structure in which a part of each magnet is exposed from the rotor holder.

As illustrated in FIG. 8, the circuit board 37 is disposed closer to the first stator core 4 than to the second stator core 5. This allows the detection element 36 to be disposed closer to the first stator core 4 than to the second stator core 5. Thus, the structure with the detection element 36 disposed at the position corresponding to the first tip gap G11 enables the detection element 36 to stably detect magnetic flux generated from the magnets 22.

As illustrated in FIG. 8, in plan view, the first tip gap G11 and the third tip gap G21 overlap each other, and the second tip gap G12 and the fourth tip gap G22 overlap each other. Thus, in plan view, a relatively wide gap of gaps between corresponding first teeth 42 adjacent to each other overlaps a relatively narrow gap of gaps between corresponding second teeth 52 adjacent to each other. In plan view, a relatively narrow gap of the gaps between the corresponding first teeth 42 adjacent to each other overlaps a relatively wide gap of the gaps between the corresponding second teeth 52 adjacent to each other. Thus, as compared with structure in which relatively wide gaps overlap each other in the axial direction AD, decrease in torque of the motor 100 can be further reduced by optimizing a counter electromotive force constant of the motor 100.

According to the present example embodiment, the plurality of first teeth 42 alternately forms the first tip gap G11 and the second tip gap G12 in the circumferential direction CD, and the plurality of second teeth 52 alternately forms the third tip gap G21 and the fourth tip gap G22 in the circumferential direction CD. In plan view, the first tip gap G11 and the third tip gap G21 overlap each other, and the second tip gap G12 and the fourth tip gap G22 overlap each other. This enables the decrease in torque of the motor 100 to be further reduced by further optimizing the counter electromotive force constant of the motor 100.

According to the present example embodiment, the first extending portion 431 and the second extending portion 432 face each other in the circumferential direction CD across the first gap G1. As a result, the first tip gap G11 and the second tip gap G12 are formed. The third extending portion 531 and the fourth extending portion 532 face each other in the circumferential direction CD across the second gap G2. As a result, the third tip gap G21 and the fourth tip gap G22 are formed. The detection element 36 is disposed at a position corresponding to the first tip gap G11. In plan view, the first tip gap G11 and the third tip gap G21 overlap each other, and the second tip gap G12 and the fourth tip gap G22 overlap each other. This enables improving sensitivity of detection of magnetic flux using the detection element 36 while preventing the motor 100 from increasing in size. Additionally, this enables decrease in the torque of the motor 100 to be further reduced by further optimizing the counter electromotive force constant of the motor 100.

Although in the present example embodiment, the circuit board 37 is disposed closer to the first stator core 4 than to the second stator core 5, the circuit board 37 may be disposed closer to the second stator core 5 than to the first stator core 4. In this case, the detection element 36 is disposed at a position corresponding to the fourth tip gap G22.

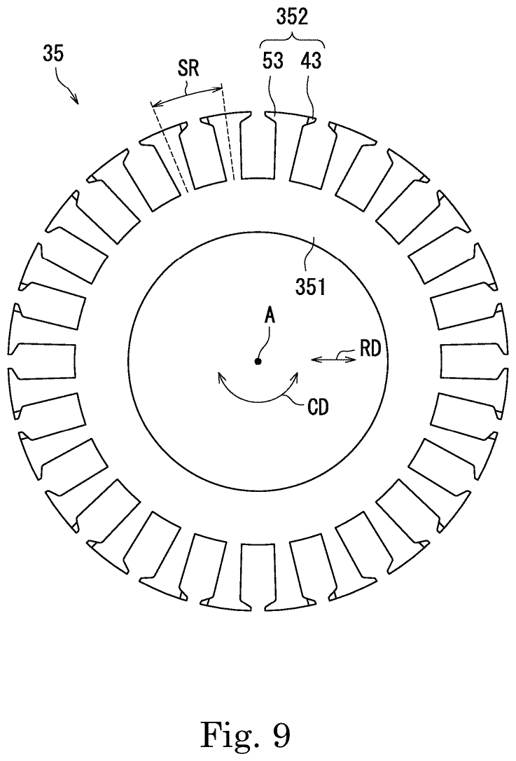

Subsequently, the stator 35 will be further described with reference to FIGS. 5A, 6A, 7A, and 9. FIG. 9 is a plan view of the stator 35. As illustrated in FIGS. 5A, 6A, 7A, and 9, the core back portion 351 of the stator 35 includes the first core back 41, and the second core back 51 stacked on the first core back 41. As illustrated in FIGS. 5A, 6A, 7A, and 9, the teeth 352 of the stator 35 includes the first teeth 42, and the second teeth 52 stacked on the first teeth 42.

As illustrated in FIGS. 6A and 7A, the first stator core and the second stator core 5 are identical in shape. As illustrated in FIG. 9, the second stator core 5 is stacked on the first stator core 4 while being displaced by one slot SR in the circumferential direction CD. The one slot SR corresponds to a distance between the centers of adjacent teeth 352. As a result, the teeth 352 each have an identical outer shape in plan view. This enables the decrease in torque of the motor 100 to be further reduced by further optimizing the counter electromotive force constant of the motor 100.

Then, the first stator core 4 and the second stator core 5 are identical in shape, so that the first stator core 4 and the second stator core 5 can be easily manufactured. For example, the first stator core 4 and the second stator core 5 can be manufactured using the same mold.

The first example embodiment has been described above with reference to FIGS. 1 to 9. Although in the present example embodiment, the detection element 36 is disposed immediately below the region through which the plurality of magnets 22 passes during rotation of the rotary assembly 2, the detection element 36 may be disposed immediately below the first tip gap G11. When the detection element 36 is disposed immediately below the first tip gap G11, the amount of magnetic flux of the magnets 22 to be detected by the detection element 36 can be increased. When the circuit board 37 is disposed closer to the second stator core 5 than to the first stator core 4, the detection element 36 may be disposed immediately above the fourth tip gap G22. When the detection element 36 is disposed immediately above the fourth tip gap G22, the amount of magnetic flux of the magnets 22 to be detected by the detection element 36 can be increased. Additionally, when the detection element 36 is disposed immediately below the first tip gap G11 or immediately above the fourth tip gap G22, the detection element 36 is disposed radially inside the stator 35. This enables the circuit board 37 to be reduced in area, so that the motor 100 can be prevented from increasing in size.

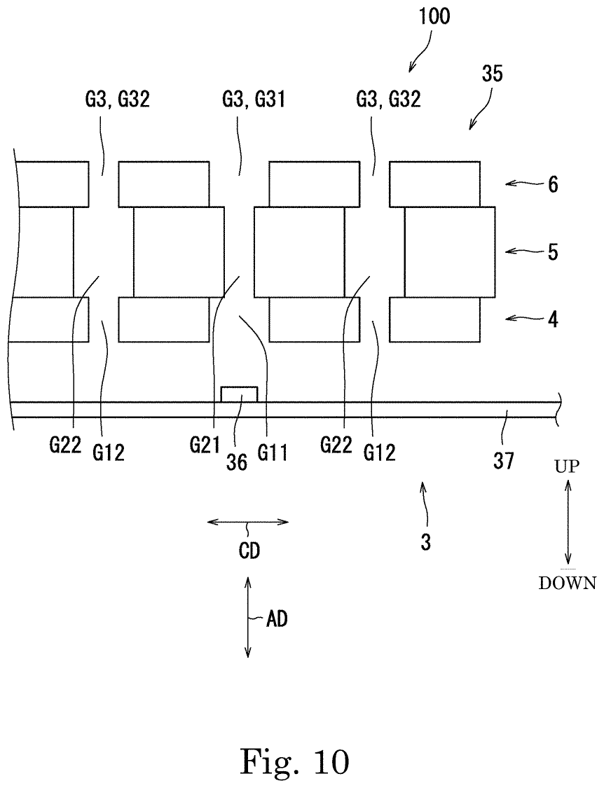

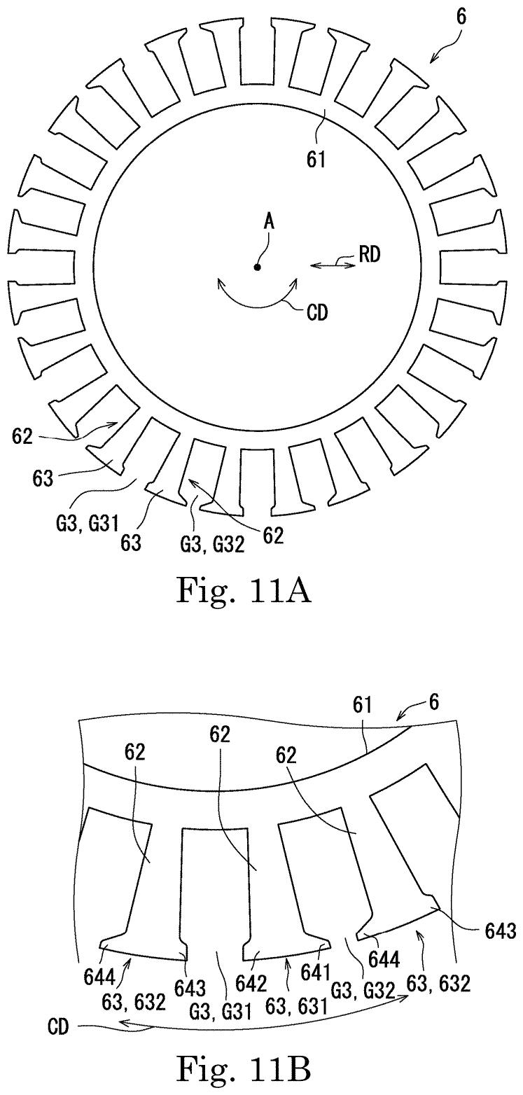

Subsequently, a second example embodiment will be described with reference to FIGS. 10, 11A, and 11B. However, items different from those of the first example embodiment will be described, and duplicated description for the same items as those of the first example embodiment will be eliminated. The second example embodiment is different from the first example embodiment in that a stator 35 includes a third stator core 6.

FIG. 10 is a schematic diagram illustrating structure of a motor 100 of the present example embodiment. Specifically, FIG. 10 illustrates the stator 35, a detection element 36, and a circuit board 37. However, in FIG. 10, a core back portion 351 is eliminated for easy understanding. As illustrated in FIG. 10, the stator 35 further includes the third stator core 6.

The third stator core 6 is stacked on a second stator core 5 on a side opposite to a first stator core 4 in the up-down direction (axial direction AD). In the present example embodiment, the third stator core 6 is stacked on above the second stator core 5 and fixed to the second stator core 5. As with the first stator core 4 and the second stator core 5, the third stator core 6 has a substantially annular structure centered on the central axis A. As with the first stator core 4 and the second stator core 5, the third stator core 6 includes a plurality of third core pieces (not illustrated) stacked in the up-down direction. The plurality of third core pieces is identical in shape. The third core pieces each have a substantially annular shape centered on the central axis A. The third core pieces are each a magnetic body in the shape of a thin plate. The magnetic bodies are each an electromagnetic steel sheet, for example.

Here, the third stator core 6 will be described with reference to FIG. 11A. FIG. 11A is a plan view of the third stator core 6. As illustrated in FIG. 11A, the third stator core 6 includes a third core back 61 in an annular shape surrounding the central axis A and a plurality of third teeth 62. The plurality of third teeth 62 is disposed along the circumferential direction CD and extends in the radial direction RD from the third core back 61. More specifically, the third core back 61 has a substantially annular shape centered on the central axis A. Here, a third tooth 62 extends outward in the radial direction RD from the third core back 61.

The third teeth 62 each include a tip portion in the radial direction RD provided with an extending portion 63. Here, an outer tip portion of the third tooth 62 in the radial direction RD has the extending portion 63. The extending portion 63 of the third tooth 62 extends in the circumferential direction CD. That is, the outer tip portion of the third tooth 62 in the radial direction RD extends in the circumferential direction CD.

The plurality of third teeth 62 includes adjacent third teeth 62 with extending portions 63 between which a third gap G3 is formed. The third gap G3 includes a fifth tip gap G31 and a sixth tip gap G32. The sixth tip gap G32 is narrower than the fifth tip gap G31. In the present example embodiment, the plurality of third teeth 62 alternately forms the fifth tip gap G31 and the sixth tip gap G32 in the circumferential direction CD. More specifically, the third stator core 6 is identical in shape to the first stator core 4.

Subsequently, the third stator core 6 will be further described with reference to FIG. 11B. FIG. 11B is an enlarged plan view illustrating a part of the third stator core 6. As illustrated in FIG. 11B, the extending portion 63 of the third stator core 6 includes a fifth extending portion 631 and a sixth extending portion 632. In the present example embodiment, the fifth extending portion 631 and the sixth extending portion 632 are alternately provided in the circumferential direction CD.

The fifth extending portion 631 has a ninth protrusion 641 and a tenth protrusion 642. The ninth protrusion 641 extends toward the first side in the circumferential direction CD with respect to the third tooth 62. The tenth protrusion 642 extends toward the second side in the circumferential direction CD with respect to the third tooth 62. The ninth protrusion 641 extends longer than the tenth protrusion 642.

The sixth extending portion 632 has an eleventh protrusion 643 and a twelfth protrusion 644. The eleventh protrusion 643 extends toward the first side in the circumferential direction CD with respect to the third tooth 62. The twelfth protrusion 644 extends toward the second side in the circumferential direction CD with respect to the third tooth 62. The twelfth protrusion 644 extends longer than the eleventh protrusion 643.

The fifth extending portion 631 and the sixth extending portion 632 face each other in the circumferential direction CD across the third gap G3. Thus, the ninth protrusion 641 faces the twelfth protrusion 644 in the circumferential direction CD. The tenth protrusion 642 faces the eleventh protrusion 643 in the circumferential direction CD. As a result, the fifth tip gap G31 is formed between the tenth protrusion 642 and the eleventh protrusion 643. The sixth tip gap G32 is formed between the ninth protrusion 641 and the twelfth protrusion 644. The fifth tip gap G31 and the sixth tip gap G32 are alternately formed in the circumferential direction CD.

As described above with reference to FIGS. 11A and 11B, the extending portion 63 of the third stator core 6 has an extended length toward the first side in the circumferential direction CD, the extended length being different from an extended length toward the second side in the circumferential direction CD. Thus, torque of the motor 100 can be increased as compared with structure in which an extending portion has short extended lengths toward both the first side and the second side in the circumferential direction.

Subsequently, referring back to FIG. 10, the structure of the motor 100 of the present example embodiment will be further described. As illustrated in FIG. 10, in plan view, the first tip gap G11, the third tip gap G21, and the fifth tip gap G31 overlap one another, and the second tip gap G12, the fourth tip gap G22, and the sixth tip gap G32 overlap one another. Thus, according to the present example embodiment, magnetic force is likely to be generated vertically and symmetrically. As a result, vibration of the motor 100 in the axial direction AD can be reduced. The reduction in vibration of the motor 100 in the axial direction AD enables noise to be reduced.

According to the present example embodiment, the plurality of first teeth 42 alternately forms the first tip gap G11 and the second tip gap G12 in the circumferential direction CD, the plurality of second teeth 52 alternately forms the third tip gap G21 and the fourth tip gap G22 in the circumferential direction CD, and the plurality of third teeth 62 alternately forms the fifth tip gap G31 and the sixth tip gap G32 in the circumferential direction CD. In plan view, the first tip gap G11, the third tip gap G21, and the fifth tip gap G31 overlap one another, and the second tip gap G12, the fourth tip gap G22, and the sixth tip gap G32 overlap one another. This enables the decrease in torque of the motor 100 to be further reduced by further optimizing the counter electromotive force constant of the motor 100.

According to the present example embodiment, the third stator core 6 is identical in shape to the first stator core 4. Thus, the first stator core 4 and the third stator core 6 can be easily manufactured. For example, the first stator core 4 and the third stator core 6 can be manufactured using the same mold.

The third stator core 6 overlaps the first stator core 4 in plan view. That is, unlike the second stator core 5, the third stator core 6 is not displaced in the circumferential direction CD with respect to the first stator core 4. Thus, the teeth 352 each have an identical outer shape in plan view. This enables the decrease in torque of the motor 100 to be further reduced by further optimizing the counter electromotive force constant of the motor 100.

The second example embodiment has been described above with reference to FIGS. 10, 11A, and 11B. As with the first example embodiment, the present example embodiment enables improving sensitivity of detection of magnetic flux using the detection element 36 while preventing the motor 100 from increasing in size. Additionally, this enables decrease in the torque of the motor 100 to be further reduced by further optimizing the counter electromotive force constant of the motor 100.

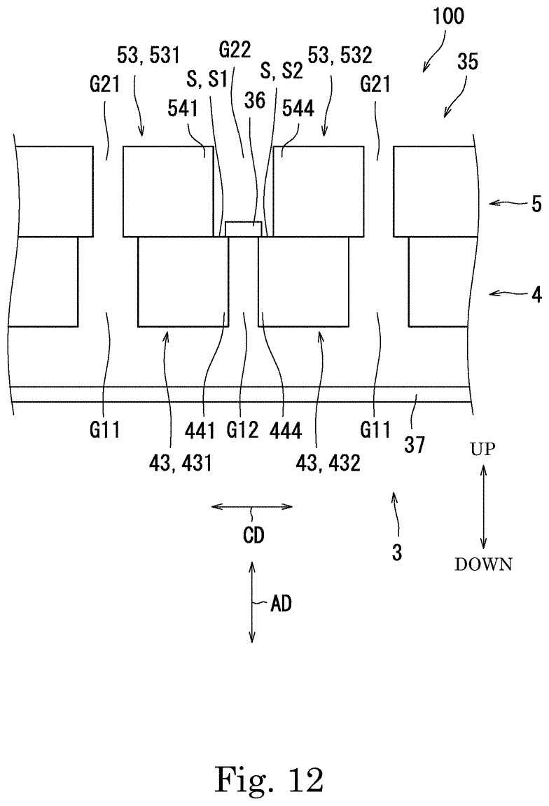

Subsequently, a third example embodiment will be described with reference to FIG. 12. However, items different from those of the first and second example embodiments will be described, and duplicated description for the same items as those of the first and second example embodiments will be eliminated. The third example embodiment is different from the first and second example embodiments in position where the detection element 36 is disposed.

FIG. 12 is a schematic diagram illustrating structure of a motor 100 of the present example embodiment. Specifically, FIG. 12 illustrates a stator 35, a detection element 36, and a circuit board 37. However, in FIG. 12, a core back portion 351 is eliminated for easy understanding.

As illustrated in FIG. 12, the present example embodiment includes the detection element 36 that is disposed in the stator 35. Specifically, a first stator core 4 includes extending portions 43 that include two extending portions 43 forming a second tip gap G12, and a second stator core 5 includes extending portions 53 that include two extending portions 53 forming a fourth tip gap G22, the two extending portions 43 and the two extending portions 53 forming steps S. In other words, the extending portions 43 of the first stator core 4 facing in the circumferential direction CD across the second tip gap G12 and the extending portions 53 of the second stator core 5 facing in the circumferential direction CD across the fourth tip gap G22 form the steps S. The detection element 36 is disposed at the steps S.

More specifically, a first protrusion 441 of an extending portion 43 of the first stator core 4 and a fifth protrusion 541 of an extending portion 53 of the second stator core 5 form a first step S1. Additionally, a fourth protrusion 444 of an extending portion 43 of the first stator core 4 and an eighth protrusion 544 of an extending portion 53 of the second stator core 5 form a second step S2. In the present example embodiment, the detection element 36 extends from the first step S1 to the second step S2, and is disposed on the first step S1 and the second step S2. In other words, the detection element 36 extends across the two steps S facing each other in the circumferential direction CD and is disposed on the two steps S.

The detection element 36 may be disposed on one of the first step S1 and the second step S2. In other words, the detection element 36 may be disposed on one of the two steps S facing each other in the circumferential direction CD.

The third example embodiment has been described above with reference to FIG. 12. According to the present example embodiment, the detection element 36 faces a magnet 22 in the radial direction RD. Thus, the detection element 36 can detect magnetic flux generated from the magnets 22 with higher sensitivity. Specifically, the amount of magnetic flux generated in the radial direction RD from the magnet 22 is larger than the amount of magnetic flux generated in another direction. According to the present example embodiment, the detection element 36 faces a magnet 22 in the radial direction RD. This enables increasing the amount of magnetic flux of the magnet 22 detected by the detection element 36. Thus, the detection element 36 can detect magnetic flux generated from the magnets 22 with higher sensitivity.

The present example embodiment facilitates positioning of the detection element 36 as compared with structure in which a detection element is mounted on a circuit board.

The example embodiments of the present disclosure have been described above with reference to the drawings (FIGS. 1 to 12). However, the present disclosure is not limited to the above example embodiments, and can be implemented in various aspects without departing from range of the gist of the present disclosure. Additionally, the plurality of components disclosed in the above example embodiments can be appropriately modified. For example, one component of all components shown in one example embodiment may be added to a component of another example embodiment, or some components of all components shown in one example embodiment may be eliminated from the one example embodiment.

The drawings schematically illustrate each component mainly to facilitate understanding of the present disclosure, and thus each illustrated component may be different in thickness, length, number, interval, or the like from actual one for convenience of creating the drawings. The structure of each component described in the above example embodiments is an example, and is not particularly limited. Thus, it is needless to say that various modifications can be made without substantially departing from range of effects of the present disclosure.

For example, although in the example embodiments described with reference to FIGS. 1 to 12, the circuit board 37 is disposed below the stator 35, the circuit board 37 may be disposed above the stator 35.

Although in the example embodiments described with reference to FIGS. 1 to 12, the detection element 36 is disposed at the position corresponding to the first tip gap G11, the detection element 36 may be disposed at a position corresponding to the fourth tip gap G22. Even when the detection element 36 is disposed at the position corresponding to the fourth tip gap G22, the detection element 36 is disposed at a position corresponding to a relatively wide gap of gaps between the extending portions 53 of the second teeth 52 adjacent to each other. This enables improving sensitivity of detection of magnetic flux using the detection element 36 while preventing the motor 100 from increasing in size.

Although the motor of an outer rotor type has been described in the example embodiments described with reference to FIGS. 1 to 12, the present disclosure can also be applied to a motor of an inner rotor type. When the present disclosure is applied to a motor of an inner rotor type, for example, a plurality of magnets is disposed on an outer peripheral surface of a rotor holder, and the rotor holder is configured to cover the entire inner peripheral surface of the plurality of magnets.

The present disclosure is useful in the field of motors.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotary assembly rotatable about a central axis extending in an up-down direction and including magnets; and
a stationary assembly that includes a stator radially opposing the magnets; wherein
the stator includes a first stator core and a second stator core stacked on the first stator core in the up-down direction;
the first stator core includes:
first core pieces stacked in the up-down direction;
a first core back in an annular shape surrounding the central axis; and
first teeth that are arranged along a circumferential direction and extend radially from the first core back;
the first teeth each include a tip portion in a radial direction provided with extending portions extending in the circumferential direction;
the first teeth include adjacent first teeth with the extending portions between which a first gap is defined;
the second stator core includes:
second core pieces stacked in the up-down direction;
a second core back in an annular shape surrounding the central axis; and
second teeth that are arranged along the circumferential direction and extend radially from the second core back;
the second teeth each include a tip portion in the radial direction provided with extending portions extending in the circumferential direction;
the second teeth include adjacent second teeth with extending portions between which a second gap is defined;
the first gap includes a first tip gap and a second tip gap narrower than the first tip gap;
the second gap includes a third tip gap and a fourth tip gap wider than the third tip gap;
the first tip gap and the third tip gap overlap each other and the second tip gap and the fourth tip gap overlap each other when viewed from the up-down direction;
the stationary assembly further includes detection elements to detect magnetic flux generated from the corresponding magnets; and
the detection elements are each provided at a position corresponding to the first tip gap or a position corresponding to the fourth tip gap.

2. The motor according to claim 1, wherein
the first teeth alternately define the first tip gap and the second tip gap in the circumferential direction; and
the second teeth alternately define the third tip gap and the fourth tip gap in the circumferential direction.

3. The motor according to claim 1, wherein
the extending portions of the first stator core include a first extending portion and a second extending portion;
the first extending portion includes a first protrusion extending toward a first side in a circumferential direction with respect to one of the first teeth, and a second protrusion extending toward a second side in the circumferential direction with respect to the one of the first teeth;
the first protrusion extends longer than the second protrusion;
the second extending portion includes a third protrusion extending toward the first side in the circumferential direction with respect to one of the first teeth, and a fourth protrusion extending toward the second side in the circumferential direction with respect to the one of the first teeth;
the fourth protrusion extends longer than the third protrusion;
the extending portions of the second stator core include a third extending portion and a fourth extending portion;
the third extending portion includes a fifth protrusion extending toward the first side in the circumferential direction with respect to one of the second teeth, and a sixth protrusion extending toward the second side in the circumferential direction with respect to one of the second teeth;
the fifth protrusion extends shorter than the sixth protrusion;
the fourth extending portion includes a seventh protrusion extending toward the first side in the circumferential direction with respect to one of the second teeth, and an eighth protrusion extending toward the second side in the circumferential direction with respect to the one of the second teeth; and
the eighth protrusion extends shorter than the seventh protrusion.

4. The motor according to claim 3, wherein
the first extending portion and the second extending portion oppose each other in the circumferential direction across the first gap; and
the third extending portion and the fourth extending portion oppose each other in the circumferential direction across the second gap.

5. The motor according to claim 1, wherein
the first stator core and the second stator core are identical in shape.

6. The motor according to claim 1, wherein
the rotary assembly further includes a rotor holder that holds the magnets;
each of the magnets includes an outer peripheral surface away from the central axis and an inner peripheral surface adjacent to the central axis; and
the rotor holder covers an entire outer peripheral surface or the entire inner peripheral surface.

7. The motor according to claim 1, wherein
the stator further includes a third stator core stacked on the second stator core on a side opposite to the first stator core in the up-down direction;
the third stator core includes third core pieces stacked in the up-down direction, a third core back in an annular shape surrounding the central axis, and third teeth that are arranged along the circumferential direction and extend radially from the third core back;
the third teeth each includes a tip portion in the radial direction provided with extending portions extending in the circumferential direction;
the third teeth include adjacent third teeth each with the extending portions between which a third gap is defined;
the third gap includes a fifth tip gap and a sixth tip gap narrower than the fifth tip gap; and
the first tip gap, the third tip gap, and the fifth tip gap overlap one another, and the second tip gap, the fourth tip gap, and the sixth tip gap overlap one another, when viewed from the up-down direction.

8. The motor according to claim 7, wherein
the third stator core is identical in shape to the first stator core.

9. The motor according to claim 1, wherein
the stationary assembly further includes a circuit board opposing the stator in the up-down direction;
the circuit board is closer to the first stator core than to the second stator core; and
the detection elements are mounted on the circuit board.

10. The motor according to claim 1, wherein
the detection elements are immediately below the first tip gap or immediately above the fourth tip gap in the up-down direction.

11. The motor according to claim 1, wherein
the extending portions of the first stator core include two extending portions defining the second tip gap, the extending portions of the second stator core include two extending portions defining the fourth tip gap;
the two extending portions defining the second tip gap and the two extending portions defining the fourth tip gap define steps; and
the detection elements are at the steps.
